(19) United States
(12) Patent Application Publication
(10) Pub. No.: US 2025/0025867 A1
(43) Pub. Date: Jan. 23, 2025

(54) REACTIVATION OF A HYDROGENATION CATALYST

(71) Applicant: Arkema France, Colombes (FR)

(72) Inventors: Jean-Marc SAGE, PIERRE-BENITE CEDEX (FR); Benoît REQUIEME, JARRIE (FR); Laurence FARINA, PIERRE-BENITE CEDEX (FR)

(21) Appl. No.: 18/717,454

(22) PCT Filed: Dec. 21, 2022
(86) PCT No.: PCT/FR2022/052465

§ 371 Date: Jun. 7, 2024

(30) Foreign Application Priority Data
Dec. 23, 2021 (FR) 2114309

(51) Int. Cl. B01J 38/66; B01J 38/02; B01J 38/52; B01J 38/56

(52) U.S. Cl. CPC B01J 38/66; B01J 38/02; B01J 38/52; B01J 38/56

(57) ABSTRACT

The present invention relates to a method for reactivating an anthraquinone hydrogenation catalyst for the preparation of hydrogen peroxide, comprising at least one step of bringing said catalyst into contact with an aqueous solution comprising ammonia. The invention also relates to the use of an aqueous ammonia solution for reactivating an anthraquinone hydrogenation catalyst for the preparation of hydrogen peroxide.

The present invention relates to the field of catalysts and more particularly to the field of hydrogenation catalysts and more specifically to the field of anthraquinone hydrogenation catalysts used in the manufacture of hydrogen peroxide.

More particularly, the present invention relates to a process for the reactivation of a hydrogenation catalyst used during the preparation of hydrogen peroxide, in particular starting from anthraquinone, which preparation comprises the three main successive stages of hydrogenation, of oxidation and of extraction. The preparation of hydrogen peroxide from anthraquinone (“anthraquinone process”) has been well known to a person skilled in the art for many years and has been extensively explained in numerous works, for example in Ullmann's Encyclopedia (G. Goor et al. (Apr. 15, 2007), https://doi.org/10.1002/14356007.a13_443.pub2).

In this “anthraquinone” process for the preparation of hydrogen peroxide, the first preparation stage consists precisely of a catalytic hydrogenation of anthraquinone. The catalyst used is usually based on a noble metal, mainly palladium, platinum or rhodium, which makes it a high-cost catalyst. Thus, when the activity of the catalyst decreases and no longer makes possible a profitable preparation of hydrogen peroxide, it is desirable to regenerate (or reactivate) this catalyst, that is to say to carry out a physicochemical treatment in order for it to regain an activity satisfactory for the requirements of the reaction for the hydrogenation of anthraquinone.

The prior art has already mentioned for many years techniques for the regeneration or reactivation of the catalyst for the hydrogenation of anthraquinone for the preparation of hydrogen peroxide. For example, the document GB 787 340 describes a regeneration of an anthraquinone hydrogenation catalyst by treatment using an alkaline solution, at a pH of greater than 12. The alkaline solution can be a sodium hydroxide solution, a solution of alkali metal carbonates or phosphates, it being possible for the treatment temperature to be, for example, 80° C. with the sodium hydroxide solution. However, this document teaches that certain types of support, such as aluminosilicates, undergo deterioration during this type of treatment.

The document EP 1 852 392 for its part describes a process for hydrogenation catalyst regeneration comprising a stage of treatment with an alkaline solution at pH 10 or higher, followed by washing of the catalyst, thus treated, with water or with a second alkaline solution which is more weakly alkaline than the first alkaline solution. However, the examples present in this document show that, compared with the activity of the initial deactivated catalyst, only a slight increase in the hydrogenation activity is observed, which starts from a pH value of 11.5.

Another technique described in the document U.S. Pat. No. 3,135,699 sets out catalyst regeneration by treatment with liquid ammonia at −80° C. The document U.S. Pat. No. 3,901,822, for its part, mentions the use of aqueous ammonium hydroxide solutions at at least 1% for 0.1 to approximately 48 hours at a temperature of between approximately 0° C. and approximately 200° C., then post-treatment under a stream of oxygen at a temperature of between 250° C. and the transition temperature of the crystalline structure of said catalyst for approximately 1 to 72 hours. Without post-treatment under a stream of oxygen, and only with a 15% aqueous ammonium hydroxide solution, this document indicates, however, that the catalyst thus regenerated deactivates again very rapidly, in particular after four days of use.

Similar hydrogenation catalysts in the field of the cracking of oil have also formed the subject of studies with a view to their regeneration. Thus, the document U.S. Pat. No. 3,214,385 deals with the regeneration of a hydrogenation catalyst by treatment of a basic solution of an alkali metal hydroxide in concentrations ranging from 1% to 50%. The document U.S. Pat. No. 3,392,111 teaches the treatment of catalysts used in the field of cracking, with aqueous or solvent-based solutions of ammonia or of amines.

The document U.S. Pat. No. 3,849,293 for its part teaches, still in the field of hydrocracking, the treatment of catalysts of the type of palladium on a zeolite (aluminosilicate) support with aqueous ammonia solutions of between 0.1% and 30% containing a dissolved ammonium salt. These treatments are carried out under conditions such that the cations of the zeolite are at least partially exchanged while contributing a desired redistribution of the noble metal from Group VIII.

The regeneration techniques of the prior art, and in particular those set out above, suffer however from numerous disadvantages when it is desired to regenerate (or reactivate) an anthraquinone hydrogenation catalyst. This is because many of these regeneration techniques usually result in chemical and/or physical modifications to the catalyst, which becomes inappropriate or unsuitable for future anthraquinone hydrogenation reactions.

For example, in a test of washing a catalyst of the type of palladium on an aluminosilicate support with 10% or 20% ammonia, at ambient temperature, a physical deterioration in the catalyst, prejudicial to the proper functioning of the filtration, by plugging of the filters at the outlet of the hydrogenator, due to the risk of formation of very fine catalyst particles which pass through the filters, was observed.

It should be understood that the reactivation of the hydrogenation catalyst envisaged in the present invention can be carried out in situ, that is to say in the very reactor where the hydrogenation of the anthraquinone takes place. It is thus important for the reactivation operation to not or only slightly cause degradation of said catalyst into fine particles, which fine particles might then result in a risk of violent decomposition of the hydrogen peroxide formed in the process during the oxidation and extraction stages.

An objective of the present invention thus consists in providing a process for reactivation of a catalyst intended for the hydrogenation of anthraquinone in the preparation of hydrogen peroxide, said process making possible the reactivation of said catalyst, under suitable conditions so that the catalyst undergoes few or no chemical and/or physical modifications, other than that of restoring, in all or at least in part, the catalytic activity of said fresh catalyst.

Yet other objectives will become apparent in the description of the invention which follows. Unless otherwise indicated, the percentages are expressed by weight.

Thus, and according to a first aspect, the present invention relates to the process for the reactivation of an anthraquinone hydrogenation catalyst in the preparation of hydrogen peroxide, comprising at least the following successive stages:
a) optional washing of the catalyst to be reactivated,
b) optional drying or draining of the catalyst to be reactivated,
c) reactivation of the catalyst to be reactivated by bringing said catalyst into contact with an aqueous solution comprising from 0.01% to 1%, preferably from 0.05% to 0.5% and more preferably from 0.1% to 0.2% of ammonia, limits included, i.e. from 0.06 to 0.12 mol·l⁻¹ of ammonia per liter of aqueous solution,
d) optional washing of the reactivated catalyst, and
e) drying or draining of said reactivated catalyst resulting from stage c) or from stage d).

The reactivation process according to the invention employs a very dilute ammonia solution. Despite this low concentration, the activity of the reactivated catalyst regains an activity which, under the conditions of the industrial process for the preparation of hydrogen peroxide, makes it possible to regain a productivity close to that obtained with a new catalyst. The purpose of the process is to remove the impurities generated by the anthraquinone hydrogenation reaction, which have become attached to the surface of the catalyst.

Moreover, the process of the invention is carried out in a reaction medium, the pH of which is less than 12, by virtue of the low ammonia concentration, and preferably the pH of the aqueous ammonia solution is of between 10 and 11 and advantageously between 10.5 and 10.8. One of the advantages associated with operating at this pH value is the lesser deterioration of the catalysts to be reactivated and in particular of the supports, very particularly the supports of aluminosilicate type.

Moreover, the use of aqueous ammonia solution in the concentration set out above differs from the basic solutions comprising alkali metals, such as, for example, sodium hydroxide solutions. Apart from the fact that sodium hydroxide solutions, widely used in the prior art, have a deleterious effect on the catalysts to be regenerated, it turns out that alkali metals, for example sodium, are harmful in the process for the preparation of hydrogen peroxide, in particular during the extraction stage, because they make phase separation difficult between the organic phase and the aqueous hydrogen peroxide phase prepared.

Yet another disadvantage associated with the use of alkaline bases, such as, for example, sodium hydroxide, is the risk of finding traces of alkali metals in the cycle of the process for the preparation of hydrogen peroxide, mainly during the hydrogenation stage. Such traces of alkali metals pose a real safety problem in the oxidation and extraction stages where they risk disturbing the manufacture, increasing the pH of the aqueous hydrogen peroxide solution and causing it to destabilize or to decompose.

Such contaminants are thus to be avoided during the catalyst reactivation. The process of the invention is freed from this disadvantage by employing an aqueous ammonia solution, preferably and very advantageously devoid of alkali metals. The aqueous ammonia solution used in the process of the invention exhibits the advantage of being easily removed, completely or at least in large part, without leaving traces during the operations of drying and draining by steam or nitrogen, during the regeneration of the catalyst.

The possible residues are in addition generally easily removed, either in the hydrogen bleedings in the hydrogenation, or also in the air exhausted at the outlet of the oxidizer, before being able to reach the extraction. In comparison, the residual sodium hydroxide or sodium carbonate will not be removed from the working solution and will thus go directly and completely into the extraction section, which presents a great danger of drift of the process and of decomposition of the hydrogen peroxide.

Thus, and as indicated above, the present invention relates to a process for the reactivation of the hydrogenation catalyst used in the industrial process, the “anthraquinone process”, for the preparation of hydrogen peroxide. The catalyst to be reactivated is generally extracted from the hydrogenation reactor for reactivation. In another embodiment, the catalyst can be reactivated in situ, that is to say in the reactor used for the stage of hydrogenation of the anthraquinone.

The reactivation of the catalyst is then obtained by bringing the catalyst to be reactivated into contact with an aqueous ammonia solution with a concentration of between 0.01% and 1%, as indicated above. It has been discovered, entirely surprisingly, that this operation of bringing into contact with said aqueous ammonia solution makes it possible for the catalyst to regain a substantial intrinsic activity of approximately 50% to 70% in a kinetic test compared to a new catalyst. This reactivation, of the order of 50% to 70%, makes it possible for the catalyst to regain satisfactory productivity conditions, close to those obtained with a new catalyst, in the hydrogenation stage in the industrial process.

Moreover, it has been observed that this activity is lasting over time and the treatment with the aqueous ammonia solution does not result in a substantial change in selectivity during the stage of hydrogenation of the anthraquinone.

In addition, and as indicated above, the process for reactivation of the catalyst according to the invention can be carried out in situ or ex situ, and this over the whole or a part only of the catalyst to be reactivated. It is also possible to carry out this reactivation of the catalyst, in whole or in part, during operation, that is to say during the operation of the industrial process for the manufacture of hydrogen peroxide by hydrogenation of anthraquinone.

The reactivation process of the invention thus makes it possible to easily reactivate a catalyst used for the hydrogenation of anthraquinone in the industrial synthesis of hydrogen peroxide. The easiness of implementation, whether over the whole or a part of the catalyst to be reactivated, and the fact of being able to carry out this reactivation in situ or ex situ, with or without shutting down the hydrogen peroxide production unit, makes it possible to eliminate periods of shutdown for replacing the spent catalyst, of cleaning residues of catalysts which have undergone chemical and/or physical deterioration, and thus make it possible to substantially increase outputs for the industrial production of hydrogen peroxide.

Stage a) of the process of the invention is an optional stage of washing the catalyst to be reactivated (also “deactivated catalyst”). This stage, if it is desired, comprises bringing at least a part or the whole of the catalyst to be reactivated into contact with a solvent in order to remove the residual quinones and hydroquinones, which can optionally be recovered and/or recycled.

According to a preferred embodiment of the invention, the solvent used in the washing stage a) can be of any type well known to a person skilled in the art and advantageously the solvent is the same as that used in the industrial process for the preparation of hydrogen peroxide. This solvent can be of any type or also a mixture of solvents, and more advantageously a mixture of polar/nonpolar solvents, as for example described in Ullmann (G. Goor et al., op. cit.).

The drying or draining stage b), which is also an optional stage, is mainly targeted at removing as much as possible the solvent potentially included in the pores of the catalyst. This drying or draining stage can be carried out according to any conventional method well known to a person skilled in the art and comprises, for example, the passage of an inert gas, such as nitrogen or oxygen-depleted air or also steam, over the catalyst to be dried or drained, the steam treatment being preferred for this operation.

Stage c) of bringing into contact with an aqueous ammonia solution can be carried out according to any method well known per se to a person skilled in the art and for example, and in a nonlimiting way, in a dedicated column or reactor, or else can also be carried out on a filter, for example the filter which was used beforehand in one or both of the stages a) and b), in particular during the extraction and/or the washing of the catalyst with the solvent.

As indicated above, the concentration of the aqueous ammonia solution used is very low and of between 0.05% and 1%. Although it is possible to carry out this operation of reactivation of the catalyst with a concentration of ammonia in water of greater than 1%, it is preferable not to go beyond this recommendation in order not to damage the catalyst, and to avoid any risk of handling more concentrated ammonia solutions, which can produce harmful ammonia vapors.

The reactivation operation, stage c) of the process of the present invention, can be carried out at any temperature. However, and for obvious reasons of ease of implementation and of effectiveness of the treatment, the reactivation is generally carried out at a temperature of between 10° C. and 80° C., preferably between 10° C. and 40° C., more preferably between 20° C. and 30° C. and very particularly advantageously at ambient temperature, that is to say in the vicinity of 25° C. However, it is possible to carry out the reactivation operation at a temperature of less than 10° C. but to the detriment of the effectiveness of the treatment. Similarly, it is possible to carry out the reactivation operation at a temperature of greater than 80° C. but at the risk of losing ammonia in the vicinity of the boiling point of water.

The reactivation stage c) can be carried out at atmospheric pressure, here again for obvious reasons of ease of implementation, but it is possible to operate at a higher pressure, for example under a slight excess pressure, for example up to 2 to 3 bar (200 kPa to 300 kPa), in particular in order to facilitate the passage of the aqueous ammonia solution through the catalyst to be reactivated.

The amounts of ammonia solution, with respect to the catalyst, can vary in large proportions, in particular as a function of the nature and of the degree of fouling of the catalyst. However, it is preferred to operate in a ratio of between 1 part and 20 parts, preferably between 1 part and 10 parts, by weight of ammonia solution per one catalyst part, more preferably between 2 parts and 5 parts of ammonia solution per one catalyst part, limits included.

On conclusion of stage c) of reactivation of the catalyst, it is possible to carry out one or more washing operation(s) with water (optional stage d)) in order to remove as much as possible the aqueous ammonia solution contained in the pores of the catalyst. This washing stage can optionally be followed by a drying or draining stage (optional stage e)) in order to remove all or part of the water contained in the pores of the catalyst, if desired. These two optional stages d) and e) can advantageously be carried out under conditions similar to those employed for stages a) and b) respectively.

The catalyst, thus reactivated on conclusion of the process of the present invention, can then be reintroduced into the reactor for the hydrogenation of anthraquinone, for the industrial synthesis of hydrogen peroxide.

The process of the present invention offers the advantage of being an operation which is simple to employ and to carry out, and in addition with very reduced risks of handling and of environmental impact, in particular because of the low concentration of ammonia used, but also because of the absence of ions of alkali metals, such as sodium, which can return to the process for the synthesis of hydrogen peroxide.

In addition, and as indicated above, the operation for reactivation of the catalyst is carried out at pH values of less than 12, typically of between 10 and 11, that is to say in a range which exhibits little or no risk of deterioration of the support of the catalyst, for example with respect to one and the same molar concentration of basic agent, such as sodium hydroxide.

The reactivation process can be employed one or more times on all or part of the same catalyst which has already been subjected to one or more reactivation processes, according to the nature of the catalyst, the degree of fouling of the catalyst and the effectiveness desired for said catalyst. As a general rule, the catalyst can thus be reactivated from 1 to 100 times, better still from 1 to 50 times, even better still from 1 to 20 times, more advantageously from 1 to 10 times.

According to a preferred embodiment, the process according to the invention consists of at least the following successive stages:
a) optional washing of the catalyst to be reactivated,
b) optional drying or draining of the catalyst to be reactivated,
c) reactivation of the catalyst to be reactivated by bringing said catalyst into contact with an aqueous solution comprising from 0.01% to 1%, preferably from 0.05% to 0.5% and more preferably from 0.1% to 0.2% of ammonia, by weight, limits included,
d) optional washing of the reactivated catalyst, and
e) drying or draining of said reactivated catalyst resulting from stage c) or from stage d).

The reactivation process according to the invention can be, if necessary or if desired, coupled with one or more other catalyst regeneration processes, such as, for example, those chosen from steam regeneration, oxidative regeneration, noble metal reimpregnation, regeneration by an acid, and others.

The catalyst capable of being employed in the process of the present invention can be of any type well known to a person skilled in the art and is a catalyst suitable for the hydrogenation of anthraquinone. As a general rule, the catalyst used in the context of the process of the invention comprises at least one noble metal, typically a metal chosen from those of columns 9, 10 and 11 of the Periodic Table of the Elements, preferably from those of columns 9 and 10 of the Periodic Table of the Elements, for example a metal chosen from palladium, platinum, rhodium, iridium, silver and gold, and also the mixtures of said metals.

The catalysts comprising at least one metal chosen from palladium, platinum, rhodium, iridium, and their mixtures, including with silver and/or gold, are very particularly preferred, and preferably the metal is palladium, optionally as a mixture with silver or gold. Examples of catalysts which can be used in the process of the invention are those which comprise, as noble metal, palladium, platinum, rhodium, iridium, a palladium/gold, palladium/silver, platinum/gold, platinum/silver, rhodium/gold, rhodium/silver, iridium/gold or iridium/silver mixture.

The catalyst generally and most often comprises a support on which the noble metal(s) is or are deposited. The support generally comprises one or more metal or nonmetal oxides, alone or as mixtures, for example aluminum oxide, silicon oxide, crystalline aluminosilicates (such as zeolites) and amorphous aluminosilicates.

Among the aluminosilicates, and according to one embodiment of the invention, the support is an aluminosilicate, preferably an amorphous aluminosilicate, that is to say a noncrystalline aluminosilicate, for example an amorphous aluminosilicate containing sodium.

The commonest and very particularly suitable catalysts are for example chosen from, and without limitation, palladium on an alumina support, palladium on an amorphous aluminosilicate support, such as those sold, for example, by Heraeus under the brand name K-0290 N.

According to a second aspect, the invention relates to the use of an aqueous solution comprising from 0.01% to 1%, preferably from 0.05% to 0.5% and more preferably from 0.1% to 0.2% of ammonia, by weight, limits included, to reactivate an anthraquinone hydrogenation catalyst intended for the preparation of hydrogen peroxide.

The process for the reactivation of an anthraquinone hydrogenation catalyst of the present invention is particularly well suited to be employed in processes for the industrial synthesis of hydrogen peroxide, commonly referred to as “anthraquinone processes”. These processes usually comprise the following three main successive stages: hydrogenation, oxidation and extraction. These processes are well known to a person skilled in the art and are widely described in the scientific literature, for example in Ullmann's Encyclopedia (G. Goor et al., op. cit.).

The invention is now illustrated using the examples which follow and which do not under any circumstances limit the invention, the scope of which is defined by the claims appended to the present description.

### Measurement of the “Intrinsic” Kinetic Activity of the Catalyst

The hydrogenation reactor is a glass-wall reactor with a capacity of one liter (1 l), equipped with a pressure sensor, capable of operating under pressure up to 10 bar absolute. It is equipped with a Rushton-type turbine equipped with a hollow shaft making possible efficient dispersion of the hydrogen by recirculation of the gases in the medium. The pressure in the reactor is kept constant during the reaction by means of a pressure regulator connected to a hydrogen reservoir making it possible to compensate for the consumption of hydrogen during the reaction in the reactor. The hydrogen consumption is measured by monitoring the decrease in pressure of the hydrogen reservoir over time. The reactor is provided with jacketed circulation making it possible to provide heating or cooling of the reactor.

400 ml of the organic working solution are introduced into the reactor. The reactor is subsequently pressurized to 3 bar (300 kPa) with nitrogen and stirring is started at approximately 150 revolutions/minute. The circulation of the jacket is started at a temperature of 65° C. When the temperature in the reactor has stabilized, the reactor is expanded to atmospheric pressure and then 3.2 g (expressed as dry weight, that is to say after passing through an oven at 110° C. for 24 hours) of a hydrogenation catalyst are introduced into the reactor. The reactor is closed again and stirring is halted.

The reactor is then placed under vacuum of approximately 0.1 bar absolute (10 kPa) and then placed under pressure of 2 bar absolute (200 kPa) of nitrogen. The purging is repeated once. The reactor is again placed under vacuum and then placed back under pressure at 2 bar absolute (200 kPa) of hydrogen. This operation is also repeated once. The hydrogen pressure in the reactor is adjusted by the hydrogen feed expansion valve.

Stirring is then started at 1500 revolutions/minute, which has the effect of dispersing the hydrogen in the medium and initiating the reaction. The hydrogen consumption is monitored over time by the decrease in the pressure (the pressure and the temperature are measured over time) of the hydrogen reservoir of known volume. When the desired degree of hydrogenation is reached, stirring is halted and then the reactor is purged. Two vacuum/argon sequences are then carried out in order to remove the hydrogen. The hydrogenated working solution is subsequently filtered and transferred under argon pressure into a receiving flask itself under argon. Heating is then halted.

The amounts of hydrogen consumed over time are converted into hydrogen peroxide equivalent, it being known that one mole of hydrogen consumed is equivalent to one mole of potential hydrogen peroxide, i.e. 34 g of hydrogen peroxide equivalent, then taken back to the volume of working solution used.

In order to compare the tests with one another, the time t(8), expressed in minutes, necessary to reach 8 g·l⁻¹ of hydrogen peroxide equivalent, is taken as base. The activity of the catalyst is then defined as the rate:

$$activity in g . {l}^{- 1} . {min}^{- 1} = 8 / t . \qquad ( 8 )$$

The following abbreviations are used subsequently:
TMB=1,2,4-trimethylbenzene,
C10=cut of Shelsoll A 150 N alkylaromatic derivatives,
Sextate=2-methylcyclohexyl acetate,
Cat=K-0290 N commercial catalyst from Heraeus, having 2% palladium on aluminosilicate.

### EXAMPLES OF TREATMENT OF A CATALYST (EXAMPLES EX1 TO EX9)

A glass column equipped with a glass frit is used, into which 20 g of a catalyst to be treated, representing a bed approximately 4 cm in height, are introduced.

The solvent or the aqueous ammonia solution is introduced into the column so as to wash the catalyst by gravity. The flow rate is adjusted dropwise by a valve located at the bottom of the column in order to ensure a flow rate of approximately 100 ml in 20-30 minutes.

The drying operations are carried out in an oven under air at a temperature of 110° C. for 24 hours. 3 catalysts (Cat-1, Cat-2 and Cat-3), which are catalysts used for a period of time of between 6 and 18 months in a hydrogen peroxide production unit, are tested. A comparative “blank” test is carried out with fresh catalyst. Examples 3, 5 and 7 are according to the present invention and the other examples are comparative examples. The results are presented in the table below:

TABLE 1

| | Ex1 | Ex2 | Ex3 | Ex4 | Ex5 | Ex6 | Ex7 | Ex8 | Ex9 |
|---|---|---|---|---|---|---|---|---|---|
| | Catalyst | | | | | | | | |
| | CAT-1 | | | CAT-2 | | CAT-3 | | Fresh catalyst | |
| Solvent | 100 ml | 100 ml | 100 ml | 100 ml | 100 ml | 100 ml | 100 ml | — | — |
| TMB | | | | | | | | | |
| washing | | | | | | | | | |
| Solvent | | 200 ml | 200 ml | 200 ml | 200 ml | 200 ml | 200 ml | — | — |
| methanol | | | | | | | | | |
| washing | | | | | | | | | |
| Drying | yes | yes | yes | yes | yes | yes | yes | yes | yes |
| 0.2% NH₃ | | — | 100 ml | — | 100 ml | — | 100 ml | — | 100 ml |
| reactivation | | | | | | | | | |
| Methanol | — | — | 200 ml | — | 200 ml | — | 200 ml | — | 200 ml |
| washing | | | | | | | | | |
| Drying | no | no | yes | no | yes | no | yes | no | yes |
| Activity | 0.73 | 0.74 | 1.43 | 0.70 | 1.57 | 1.68 | 1.78 | 2.40 | 2.39 |

The particle size dispersion of the catalyst was checked for examples 1 and 3. The results show that the catalyst does not undergo any degradation resulting in fracturing of the catalyst beads or the formation of fines (see Table 5 below).

The comparison of examples 8 and 9 shows that the reactivated catalyst exhibits an activity comparable to the fresh catalyst. It is deduced therefrom that the dispersion of the catalyst is not modified.

### EXAMPLES OF TREATMENT OF A CATALYST (EXAMPLES EX10 TO EX14)

In this second series of examples 10 to 14, the first washing of the catalyst is carried out with different solvents, or while omitting this stage. The drying stage before the treatment with the aqueous ammonia solution was also omitted. Finally, the last washing with methanol is replaced by simple washing with water, followed by drying.

Another catalyst (Cat-4), which is a catalyst used for a period of time of between 6 and 18 months in a hydrogen peroxide production unit, is tested. Examples 11, 12 and 13 are according to the present invention and examples 10 and 14 are comparative examples. The results are presented in the table below:

TABLE 2

| | Ex10 | Ex11 | Ex12 | Ex13 | Ex14 |
|---|---|---|---|---|---|
| Catalyst | CAT-4 | | | | |
| Solvent | TMB | C10 | — | Sextate | C10 |
| | 100 ml | 100 ml | | 100 ml | 100 ml |
| 0.2% NH₃ | — | 100 ml | 100 ml | 100 ml | — |
| reactivation | | | | | |
| Washing with water | — | 200 ml | 100 ml | 200 ml | 200 ml |
| Drying | — | yes | yes | yes | yes |
| Activity | 0.74 | 1.31 | 1.30 | 1.13 | 0.77 |

For example 12, the reactivation treatment with the ammonia solution was carried out in a flask stirred laterally by approximately 20-30 swings per minute, so as not to cause attrition of the catalyst, and at 50° C.

These results show that the treatment with an aqueous ammonia solution, even at low concentration, according to the process of the invention, makes possible in all cases a satisfactory reactivation of the catalyst.

### EXAMPLES 15-17: REACTIVATION OF CATALYST AND REUSE CONTINUOUSLY IN THE ANTHRAQUINONE PROCESS

For these examples, a new catalyst K-0290 N from Heraeus (Ex15), 60 g of used catalyst Cat-5, resulting from an industrial production unit and containing approximately 50% of working solution after simple filtration (Ex16), and 60 g of used catalyst Cat-5, resulting from an industrial production unit and containing approximately 50% of working solution after simple filtration (Ex17), are used, which catalysts are subjected to the following treatments:
washing with 600 ml of methanol,
rinsing with 100 ml of demineralized water,
reactivation with 400 ml of 0.2% aqueous ammonia solution,
washing with 400 ml of demineralized water, and
drying at 110° C., for 24 hours.

The flow rates of reactivation solution are regulated for a duration of approximately 40 minutes to 60 minutes per treatment. 33.5 g of dry reactivated catalyst, subsequently referred to as Cat-5 ttNH₃, are thus recovered.

### Evaluation of the Catalyst

The catalysts of examples 15 to 17 are employed in a pilot plant operating continuously according to the anthraquinone process. The total volume of working solution in the plant is of between 45 l and 55 l. The flow rate of working solution is 16 l·h⁻¹.

The reaction is carried out in a reactor stirred by a turbine having a hollow shaft making it possible to disperse the hydrogen and to keep the catalyst in suspension in the working solution.

The level of the reactor is regulated so as to maintain a mean reaction volume of 7 l. The hydrogen is injected with a constant flow rate of 500 l·h⁻¹. The pressure is adjusted by a solenoid valve to 1.25 bar relative (226 kPa), the excess hydrogen being removed through a vent. The reaction temperature is maintained at 65° C. The hydrogen peroxide equivalent is controlled by additions of catalyst.

The working solution is subsequently filtered and then sent to the oxidation reactor. Oxidation is carried out in a tubular reactor with an internal diameter of 7 cm and a height of 237 cm, operating countercurrentwise. The working solution is injected at the top and air is injected at the bottom through a sintered stainless steel diffuser. The reactor is filled with packing.

A solenoid valve placed at the top of the oxidation reactor makes it possible to adjust the pressure to 1.8 bar relative (281 kPa). The air flow rate is 900 l·h⁻¹. The reaction temperature is maintained on average in the reactor at 60° C.

The working solution is subsequently injected into the extraction section, consisting of 3 plate columns, placed in series, each operating countercurrentwise. Water is injected at the top, while the working solution is injected at the bottom. The water flow rate is fixed at 0.5 l·h⁻¹. The working solution resulting from the extraction stage is separated from the water before being reintroduced into the hydrogenation reactor.

The amount of catalyst deployed to reach a degree of hydrogenation corresponding to 9 g·l⁻¹ of hydrogen peroxide per liter of working solution (equivalents) at the hydrogenator outlet makes it possible to compare the effectivenesses of the catalysts.

Examples 15 and 16 are comparative and example 17 is according to the invention. The catalyst of example 16 (Ex16) is a catalyst Cat-5 washed with methanol and then dried, as indicated above. The pilot plant continuously produces hydrogen peroxide. The number of days elapsed up to a loss in the number of hydrogenation equivalents of 1 g·l⁻¹ is recorded. The results are presented in the table below:

TABLE 3

| | Ex15 | Ex16 | Ex17 |
|---|---|---|---|
| | New catalyst | CAT-5 | Cat-5_ttNH₃ |
| Amount of catalyst to | 15 to 20 g | more than 50 g | 20 to 25 g |
| reach 9 g · 1⁻¹ | | | |
| Number of days | >15 days | 7 days | >15 days |

### Analyses

### Analyses of a Deactivated Catalyst

The catalyst Cat-2 was analyzed before (Ex4) and after (Ex5) treatment with an ammonia solution. The resulting aqueous ammonia solution is then analyzed by proton NMR and carbon-13 NMR.

NMR analysis of the ammonia solution obtained after treatment shows the predominant presence of 4-ethylbenzene-1,2-dicarboxylic acid (“ethylphthalic acid”). The presence of oxalic acid and phthalic acid is also recorded. Without prejudice to the invention, it is thought that the ethylphthalic acid, originating from degradation side reactions of ethylanthraquinone derivatives present in the working solution, becomes fixed with the formation of an insoluble carbon-based layer at the surface of the catalyst, obstructing the pores of the catalyst and thus limiting its activity.

From the weight of the dry extract obtained with regard to this solution, the amount of ethylphthalic acid and of oxalic acid which were fixed to the catalyst is estimated at approximately 1% to 3%, with respect to the dry catalyst.

Scanning electron microscope (SEM) analysis of the catalyst surface clearly shows that the ammonia treatment makes it possible to remove entities tending to form a layer on the catalyst.

The analyses of elemental composition by X-ray fluorescence at the surface of grains show that the composition of the catalyst before and after regeneration by ammonia remains substantially identical. The sodium content is not greatly impacted by the treatment with a dilute ammonia solution. It is also seen that the operation of treatment with ammonia does not cause a change in the palladium content at the surface of the grains.

The X-ray fluorescence analyses are carried out with a JSM-IT500 LA scanning electron microscope from Jeol. The samples are deposited on aluminum studs provided with carbon adhesives. Images are recorded at magnifications of between ×100 and χ600. EDX spectra and maps are produced to determine the elemental composition of the surface of the grains of catalysts. The results of the analyses of elemental compositions for Ex4 and Ex5 are presented in the table below:

TABLE 4

| Spectrum | | | | |
|---|---|---|---|---|
| No. | Na | Al | Si | Pd |
| Ex4 | 6.7-6.6 | 8-7.9 | 19.7-19 | 2 |
| Ex5 | 6.1-6.3 | 8.4-8.3 | 20-21 | 1.9-2 |

### PARTICLE SIZE ANALYSES OF THE TREATED CATALYSTS (EXAMPLES 1 AND 3)

The particle size measurement is carried out according to the wet laser diffraction technique using a Masterziser® S appliance sold by Malvern. The measurement is carried out by dispersing the catalyst powder in water in the presence of a drop of Igepal® (ethoxylated nonylphenol) surfactant, rate 2500 adjusted on the appliance. The values are recorded after 10 minutes of circulation in the measurement cell.

Diameter at 10%, 50% and 90% of the population (by volume)

The results are presented in the table below:

TABLE 5

| Sample | Φ (0.1) in μm | Φ (0.5) in μm | Φ (0.9) in μm |
|---|---|---|---|
| Ex3 | 82 | 118 | 171 |
| Ex2 (Comp.) | 88 | 119 | 161 |

It is seen that the treatment with a 0.2% ammonia solution does not significantly modify the particle size characteristics of the catalyst.

A similar palladium on aluminosilicate support catalyst treated in the same way and conditions as in example 5 but with a 20% ammonia solution is for its part highly damaged: the catalyst grains are fractured by the treatment. In addition, the same effect was observed with a 10% ammonia solution.

1-10. (canceled)

11. A process for the reactivation of an anthraquinone hydrogenation catalyst in the preparation of hydrogen peroxide, comprising at least the following successive stages:
a) optional washing of the catalyst to be reactivated,
b) optional drying or draining of the catalyst to be reactivated,
c) reactivation of the catalyst to be reactivated by bringing said catalyst into contact with an aqueous solution comprising from 0.01% to 1%, of ammonia, by weight, limits included,
d) optional washing of the reactivated catalyst, and
e) drying or draining of said reactivated catalyst resulting from stage c) or from stage d).

12. The process as claimed in claim 11, in which the reaction temperature of stage c) is between 10° C. and 80° C.

13. The process as claimed in claim 11, in which the reactivation stage c) is carried out at atmospheric pressure or under an excess pressure up to 200 kPa to 300 kPa.

14. The process as claimed in claim 11, in which the amount of ammonia solution employed in the reactivation stage c), with respect to the catalyst, is in a ratio of between 1 part and 20 parts, by weight of ammonia solution per one catalyst part, limits included.

15. The process as claimed in claim 11, in which the optional washing stage of stage a) comprises bringing at least a part or the whole of the catalyst to be reactivated into contact with a solvent.

16. The process as claimed in claim 11, in which the optional drying or draining stage b) comprises passing an inert gas over the catalyst to be dried or to be drained.

17. The process as claimed in claim 11, coupled with one or more other catalyst regeneration processes, selected from the group consisting of steam regeneration, oxidative regeneration, noble metal reimpregnation, and regeneration by an acid.

18. The process as claimed in claim 11, in which the catalyst comprises at least one noble metal, chosen from columns 9, 10, and 11 of the Periodic Table of the Elements, and also mixtures of said metals.

19. The process as claimed in claim 11, in which the catalyst comprises a support, said support comprising one or more metal or nonmetal oxides, alone or as mixtures.
